(19) United States
(12) Patent Application Publication
(10) Pub. No.: US 2010/0326981 A1
(43) Pub. Date: Dec. 30, 2010

(54) Triptik agregat

(76) Inventor: Rexhep Hasimi, Chicago, IL (US)

Correspondence Address: REXHEP HASIMI, 855 W. ALDINE #1402, CHICAGO, IL, 60657, US

(21) Appl. No.: 12/387,509

(22) Filed: May 4, 2009

(51) Int. Cl. H05B 3/34

(52) U.S. Cl. 219/528

(57) ABSTRACT

The Skyline Electric Cover for car is assembled at the front of automobile this is pull with a hook to cover the car and melt the snow or ice. The car is completely cover with the Electric Blanket from the Skyline horizontally up to behind the car trunk and closed with a key with code. For uncovering the automobile the lock is open and the Skyline makes automatically the draw of the electric cover of car inside of itself.

The Skyline Cover for cars is assembled behind the automobile for the protection of dust. It has the same system like the electric cover but not electric blanket.

The Skyline Electric Cover for airplane melt snow for commercial and military airplanes, it has the electric blanket and also protect de airplanes from ice and snow.

### VERSION ONE

As everyone knows in the most of countries in northern hemisphere and some other areas of the world the winter season which lasts for 3-4 months of the year is associated with rain and snow precipitations and ice. People over centuries have found ways to protect themselves and their dwellings from precipitations and ice. Yet as today, there is no convenient method as how to clean off the snow and ice from that covers for day and night during 3-4 months every year all the cars, airplanes and helicopters which are parked outside in the open or on the streets near houses and businesses.

To my understanding, almost all the vehicles in the world are in contact with snow and ice because even those vehicles that are parked in garage during the day or night by the houses, will come in contact with snow and ice when they are driven off on the road or parked outside workplaces, houses, and other business place in the open.

It is a well known fact that for majority of people will spend 20-30 minutes to clean the snow off their cars when they are about to leave home for work, after work, and when they are to go home right after the snowfall. People have to use different tools like brushes etc. to get the snow and ice off their cars windshield and body in the cold, sometimes many times a day while they are tired and exhausted during the day or night time. This exhausting procedure in day or night time during 3-4 months of winter is not pleasant, on the contrary it is hard and disliked, for all those people who have to go through this procedure during their lifetimes.

This problem is the same for the people ever since the cars were made popular. Even today the snow cleaning tools remain the same. So does the winter, it is cold, harsh, with rains and snowfalls and ice.

Those worries, well known to all as they are to me, stirred my imagination and my fantasy which has given me as a gift one new, convenient and practical idea. I am pleased to give this idea as a gift to people of the whole world who face snow and ice covering their vehicles in winter. I want this product-idea to be in the ownership of all.

To make it understandable to everyone as what my idea represents, I have built two mini-models
A) For cars
B) For helicopters and airplanes
My models show visually all the details that make up this new product, which I have named:
Skyline for melting of snow and ice over cars and airplanes that are parked outside on the street or in the open field.
For examples please see pictures.

### VERSION TWO

My Idea is proposing an Skyline Cover that is a mixed product a MECHANICAL SYSTEM FOR PROTECTING CARS FROM DUST AND LEAVES which is built of three existing and well known products of simple functioning which have been invented before by other inventors.

The three new and original products above are with a few changes suited and adapted to one another by my imagination. Each one in itself has a specific function, whereas the three connected together in my new idea they represent a new mixed—product, which creates a new application,—a new important and original business. This new product was missed for many years and is still missing now days in the third millennium to make easy melting of snow and ice that is covering cars, helicopters and airplanes in many countries in the world during winter.

I would like to add as follows that these three products as I have written above, bring up another idea which I have mentioned in the beginning as VERSION 2 Skyline Electric Blanket FOR MELTING OF SNOW AND ICE which is similar to VERSION 1 ELECTRO-MECHANICAL SYSTEM FOR MELTING OF SNOW AND ICE.

VERSION 2 SKYLINE FOR PROTECTING CARS FROM DUST AND LEAVES. Makes practical to cover the cars for protection from dust and tree leaves.

Version 2: MECHANICAL SYSTEM FOR PROTECTING CARS FROM DUST AND LEAVES. has two differences compare to version 3: ELECTRO-MECHANICAL SYSTEM FOR MELTING OF SNOW AND ICE

First difference will be that product SKY LINE will not contain within product ELECTRIC BLANKET but will contain another product of the name CAR COVERS which will be used to cover the car in the season of fall.

The second difference is that the Base of BUS BIKE HOLDER which will hold product SKY LINE in front of the car in this case will be mounted on the rear of the car while holding product SKY LINE. which on this case will contain within product of name CAR COVERS; you can see pictures.

This idea similar to the first one, Version 2, I will introduce after version 1, because I think that if I do not introduce version 2 here, then someone else would try to bring it to US Bureau of Patents as his own invention.

Idea SKYLINE FOR MELTING OF SNOW AND ICE version 1 is built after adaptation of three existing and well known products:
Product 1 known by the name RETRACTABLE HOLDER—picture No. 20
Product 2 known by the name ELECTRIC BLANKET.
Product 3 known by the name BUS BIKE HOLDER.

Adaptation of these three products is logical and simple, without changing their existing function; on the contrary by coordinating their existing functions we achieve to realize perfectly the idea in two systems, two versions of Skyline Electric Blanket for melting ice and snow and SKYLINE FOR PROTECTING CARS FROM DUST AND LEAVES.

Product retractable holder is a well known product by public as what purpose it is used for and how to use it.

Product ELECTRIC BLANKET is a product similar to product ELECTRIC BLANKET known with the name HEATING PAD. They are popular products.

Product ELECTRIC BLANKET is currently used in Hospitals where it is used as a warming cover for patients when they are just coming out of Operation Room. This product is of a large size, as large as the operation bed for a patient.

Product HEATING PAD is sold in pharmacies to consumers and has small dimensions.

In both products ELECTRIC BLANKET and HEATING PAD. inside them is applied the same principle, similar to that of the electrical wires inside the rear window in the cars. Everybody knows that this set of electrical wires are placed inside the rear window of a car to melt down ice and snow when it is turned on.

After introducing products No 1 and No 2 and their functions in this system, to better understand how to use my system and how I have made this adaptation among three products, I am introducing Product #3 BUS BIKE HOLDER alongside with The Skyline Electric Blanket.

Product No. 3 like a BUS BIKE HOLDER and it will support product No. 1 retractable holder and product No. 2 ELECTRIC BLANKET; The product No. 3 will be mounted on the front of the car.

As a conclusion from presentation of three products

The Idea that I am proposing here is clear and understandable, as I have introduced here three products and their real functions.

For a recap, I am mentioning names of the three products that make possible for creating of my system for Melting of ice and Snow over Cars, Airplanes and Helicopters in Winter.

Product No. 1 Retractable Holder will carry within itself product No. 2 ELECTRIC BLANKET and product N 3 a holder like a BUS BIKE HOLDER will support products retractable holder and ELECTRIC BLANKET which will be placed in front on the car.

These three products as above, put together in a functioning system materialize my idea which I have named:

“SKYLINE ELECTRIC BLANKET FOR MELTING OF ICE AND SNOW OFF THE TOP OF CARS, AIRPLANES AND HELICOPTERS WHEN THEY ARE PARKED OUTSIDE ON THE STREET, IN NATURE”

My Idea SKYLINE COVER FOR PROTECTING CARS FROM DUST AND LEAVES. Version No. 2 is similar to version No. 1 but has two differences.

First difference is that the retractable holder will contain inside a fabric made of cotton or micro fiber without an electric system which is called CAR COVERS

Second difference is that the support like a BUS BIKE HOLDER will be mounted on the rear of the car, below the rear lights, and this base will hold the Retractable Holder which contains product CAR COVERS inside its body.

Skyline Cover to protect car from dust and leaves will be mounted and use by people, as they want, in Summer time to keep their cars clean of the street dust and keep clean of tree leaves in the Fall.

Product SKYLINE CAR COVER is wider in both sides but it has an extra fold which is folded up and kept folded by clip buttons or a zipper.

Both sides of the SKYLINE CAR COVER are zipped up or buttoned up with clip-buttons when product CAR COVERS stays inside of the retractable holder. Both sides of product CAR COVERS will be unfolded and almost the ground when product CAR COVERS. is opened over the car.

Besides cars, Airplanes and helicopters stay parked outside in the open and get covered with ice and snow in the winter. Cleaning off the snow and ice from airplanes and helicopters takes a great deal of hard work and is not convenient at all.

### VERSION THREE

My SKYLINE ELECTRIC COVER FOR MELTING OF SNOW AND ICE makes possible a quick, convenient and simple method for melting of ice and snow that covers airplanes, helicopters and other vehicle that stay parked in the open.

In the case of airplanes and helicopters Skyline Electric Cover will have another type of support, different of the one that I used for cars like the BUS BIKE HOLDER; There will be another Base of support which is made up of parts as explained below.

The new base of support on which the Retractable Holder is set, will hold a bigger ELECTRIC BLANKET

The base of support will be built of parts as detailed below:

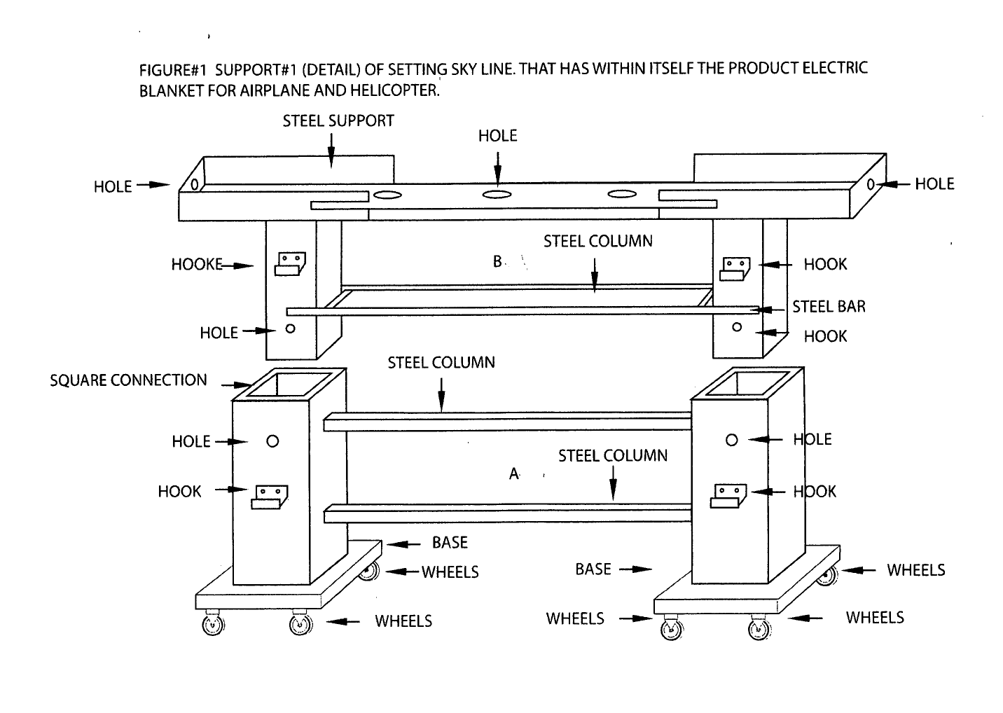

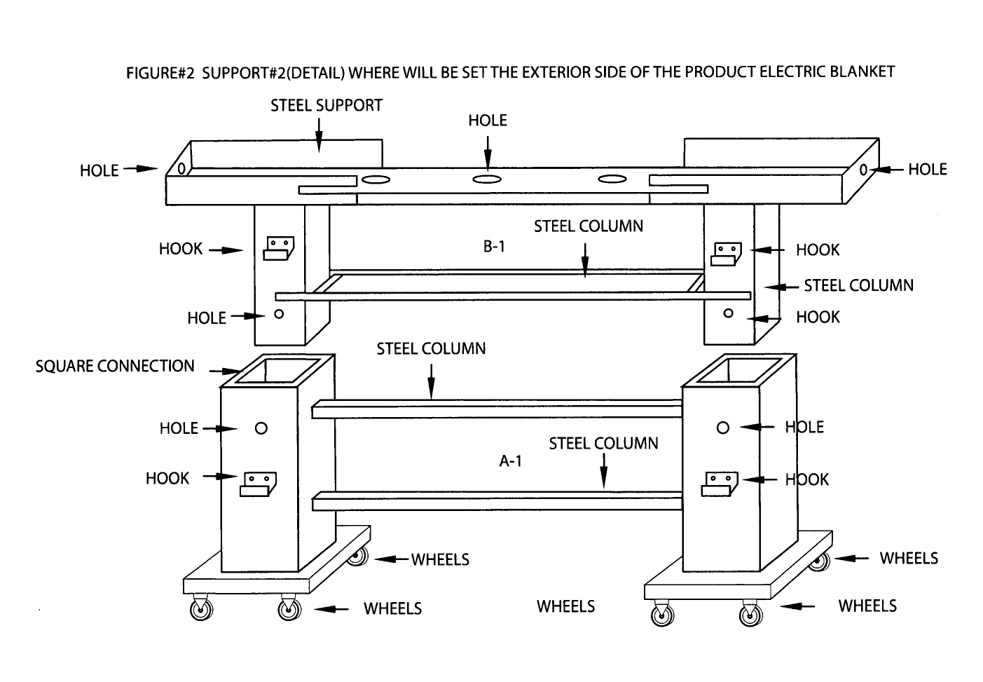

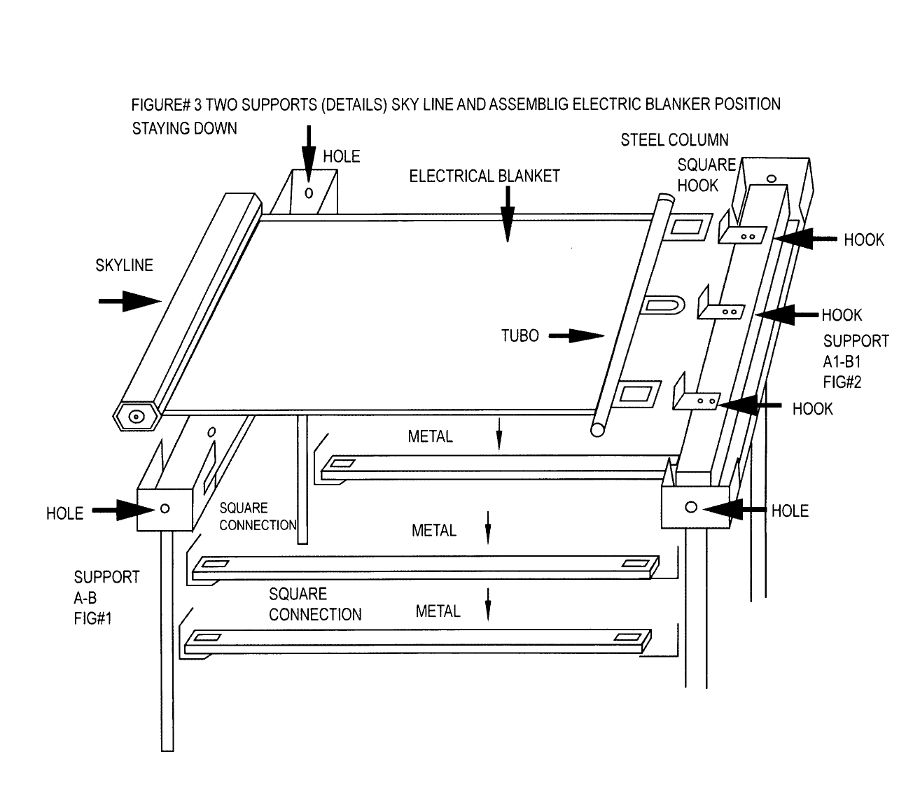

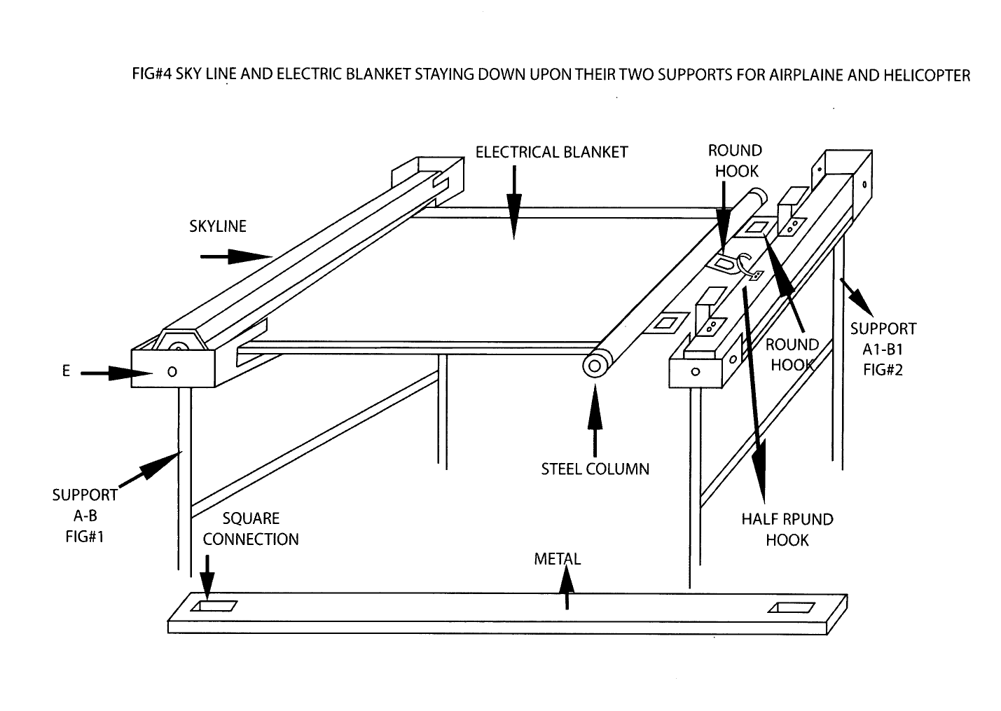

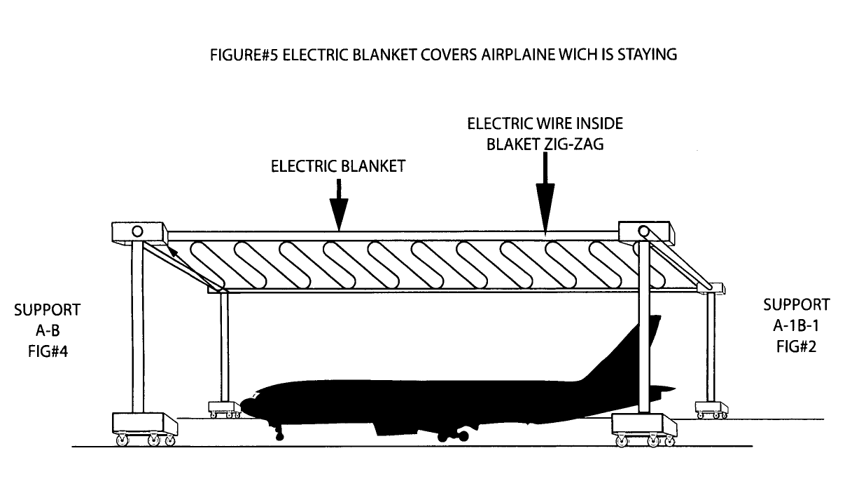

As shown in FIG. 1 there are two parts, Part A. and part B, where the upper part b will be placed on lower part A. Part A stands on a set of wheels, so that base of support can easily move for transporting it as needed.

SKYLINE ELECTRIC BLANKET will be placed on part B.

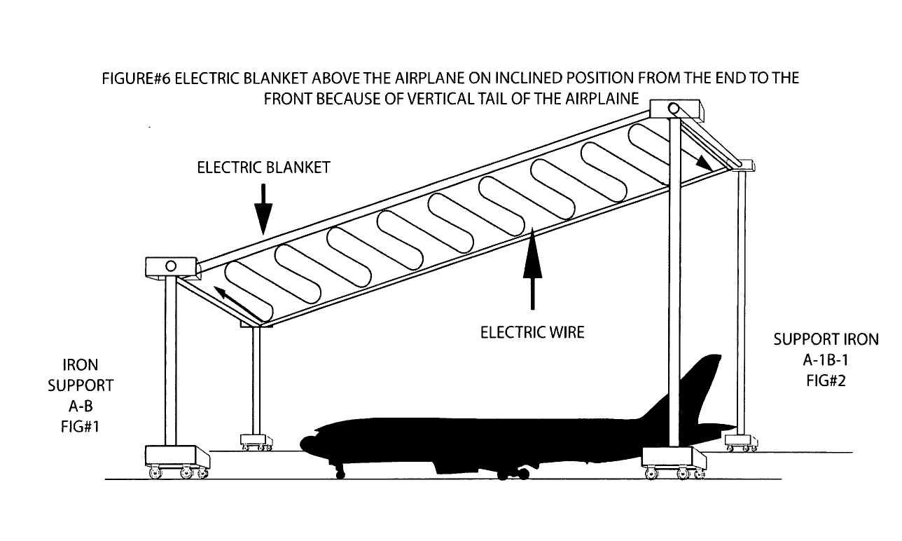

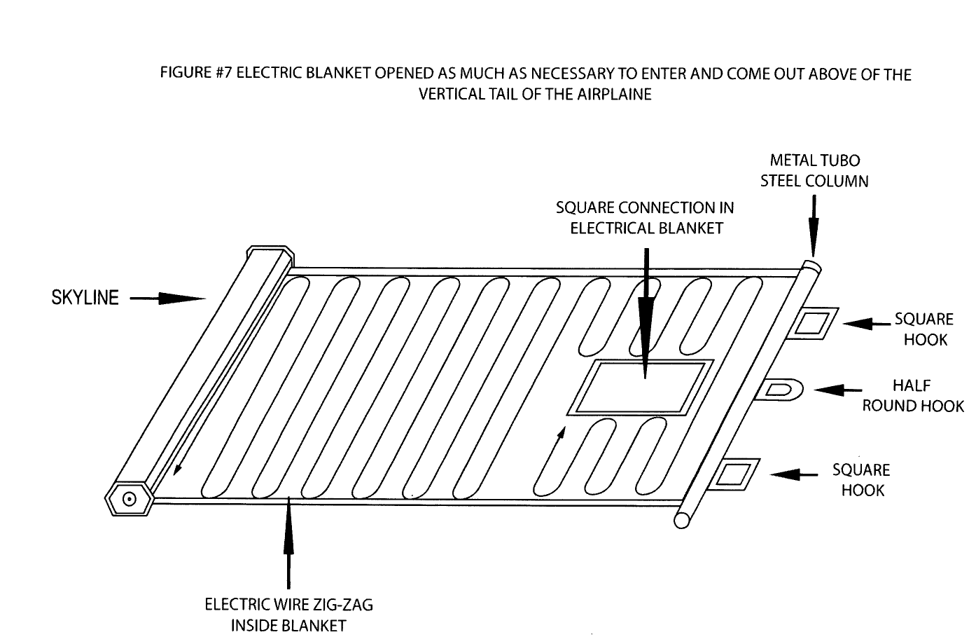

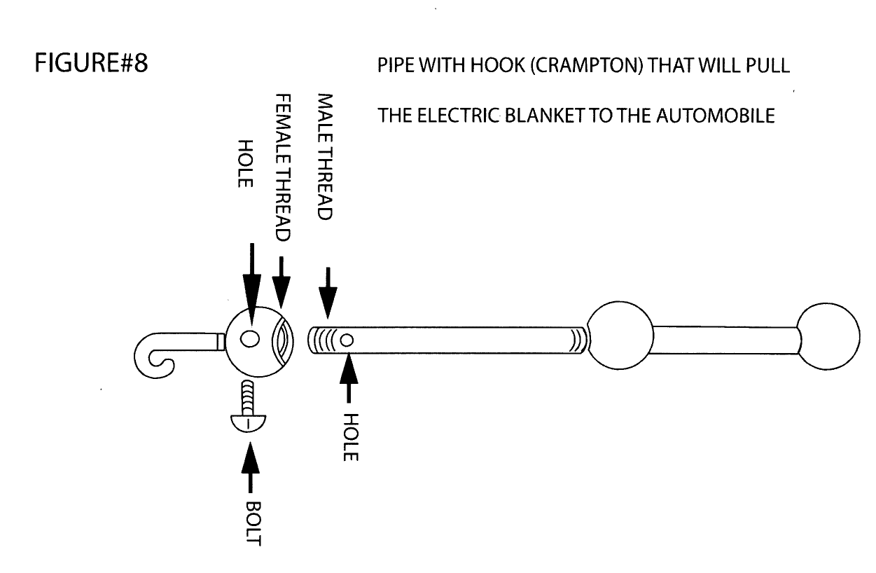

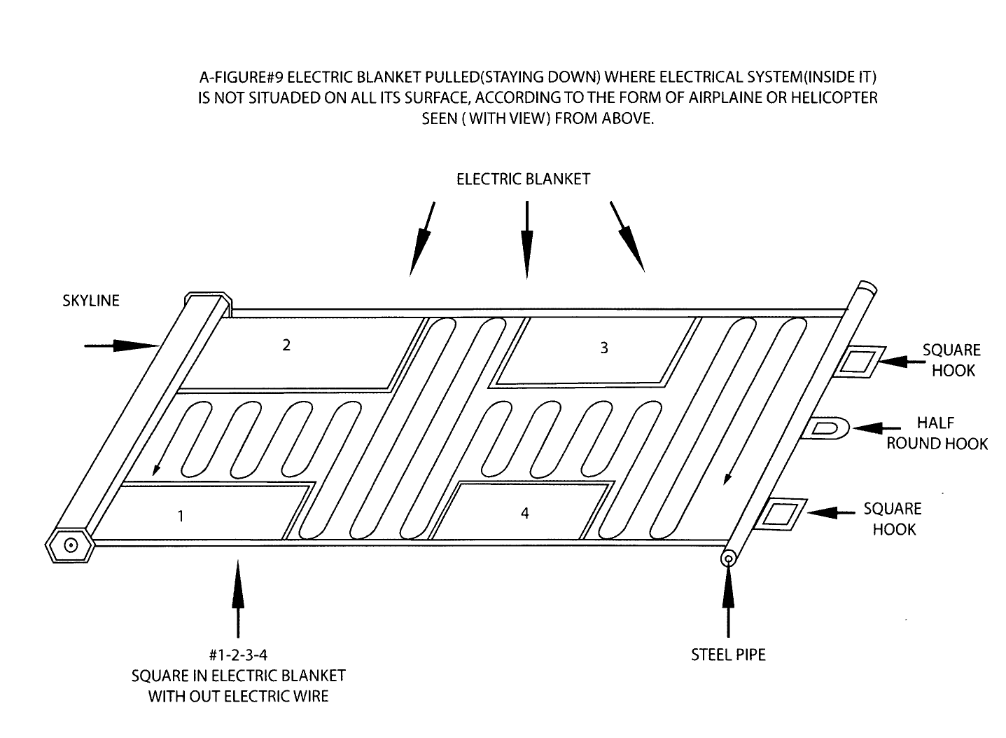

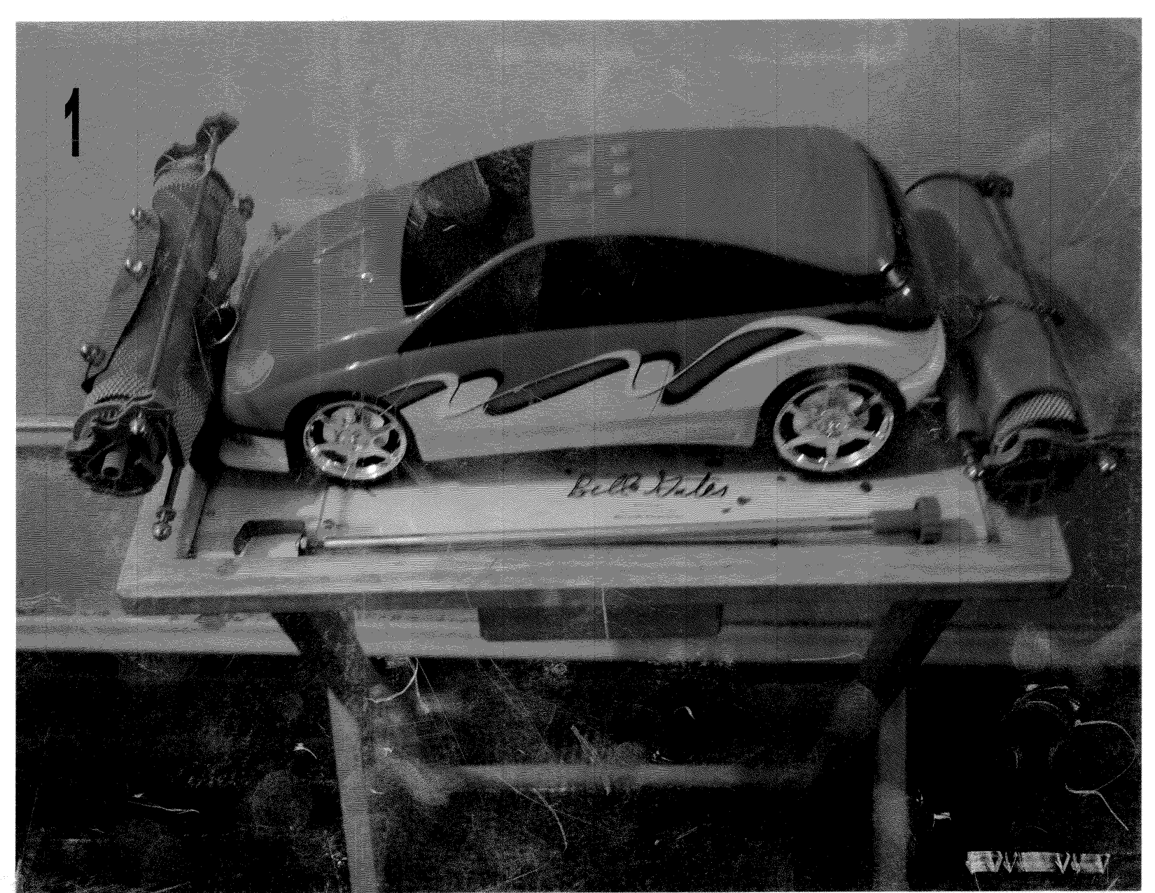

In FIG. 2 are shown parts A1 and B1 which are positioned at the other end of the airplane or helicopter. These parts A1, B1 are the same as A and B. Both upper parts B and B1 are built with a system which allows the user to lower and rise them according to the height of airplane or helicopter. Parts B and B1 will fit into parts A and A1 respectively and will go up and down as needed.

The base of support will hold product SKY LINE ELECTRIC BLANKET inside RETRACTABLE HOLDER and respective parts A, B, A1, B1; I am only showing the idea as how this BASE OF SUPPORT will be built, its parts and how it will be adjusted for different heights and how it will move horizontally on wheels etc. when is time to make industrially, it will be built with the most up to date technology by following my idea.

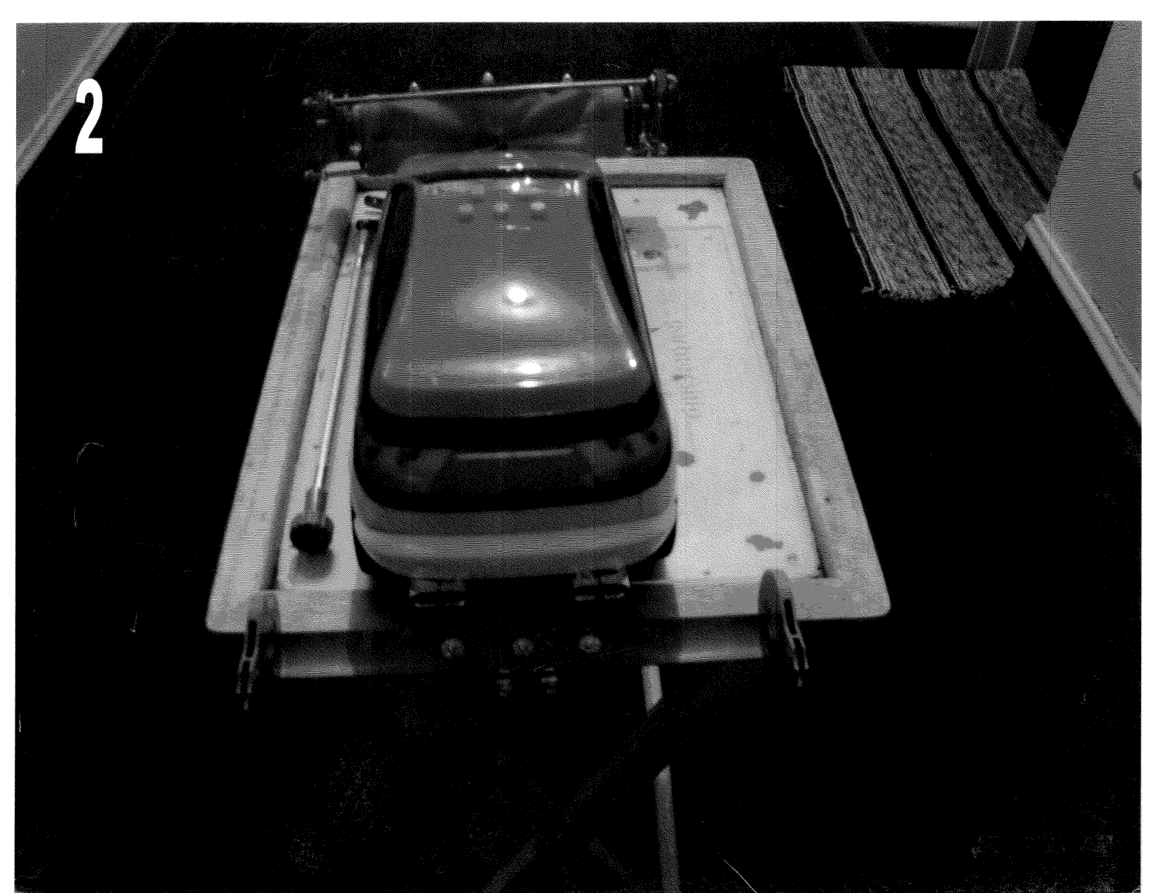

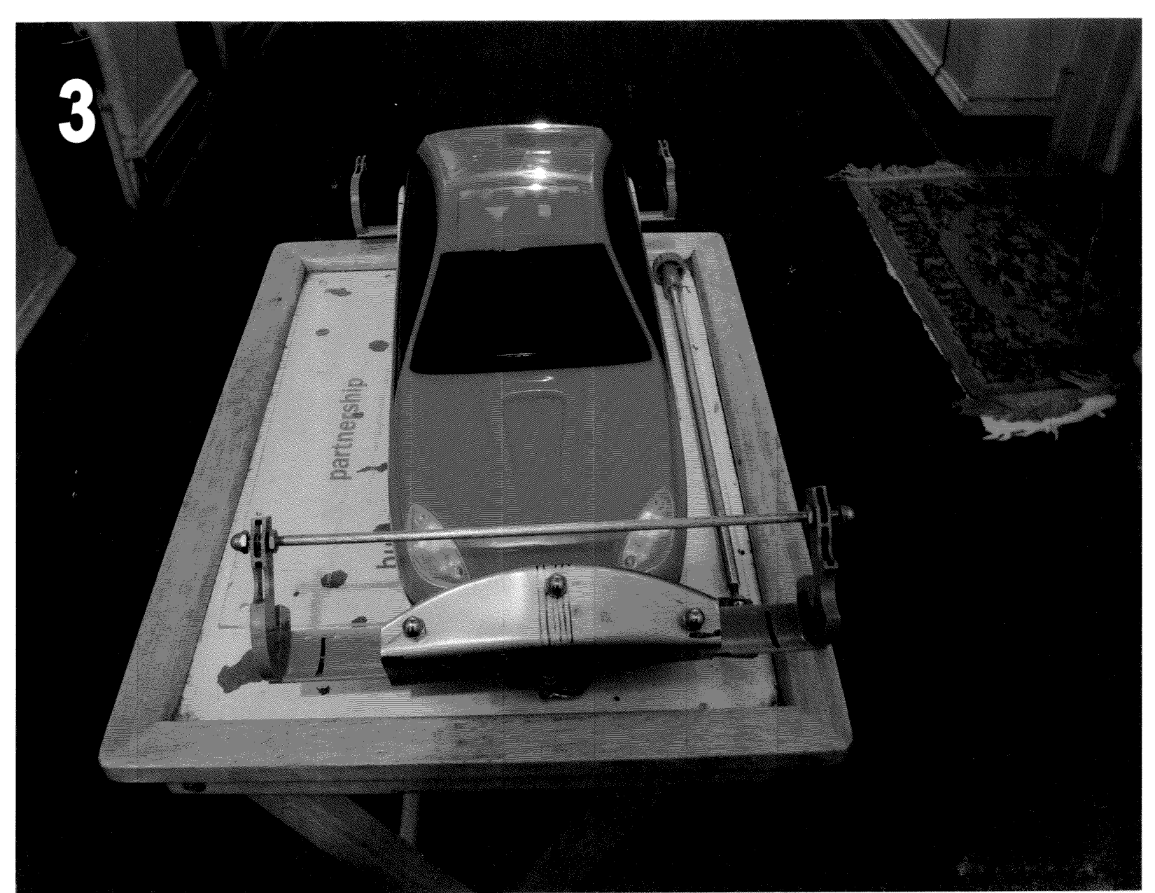

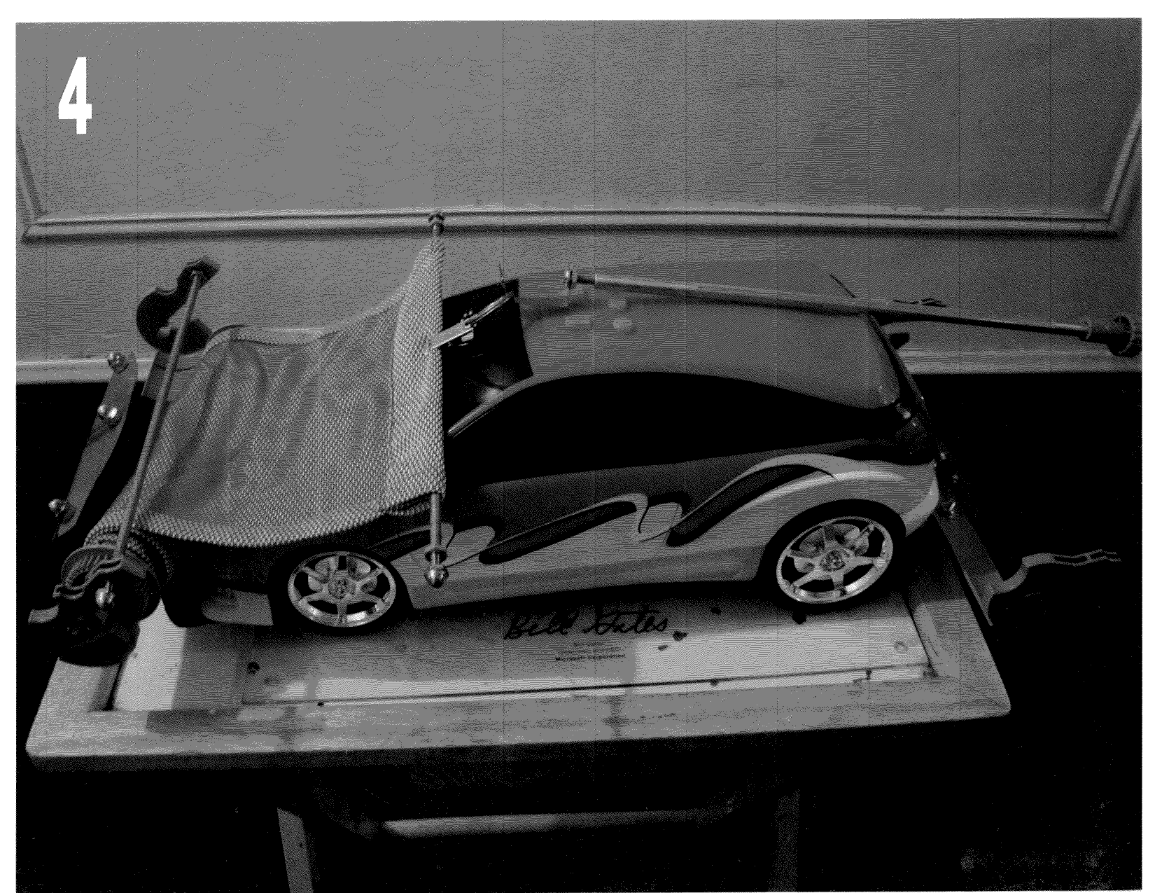

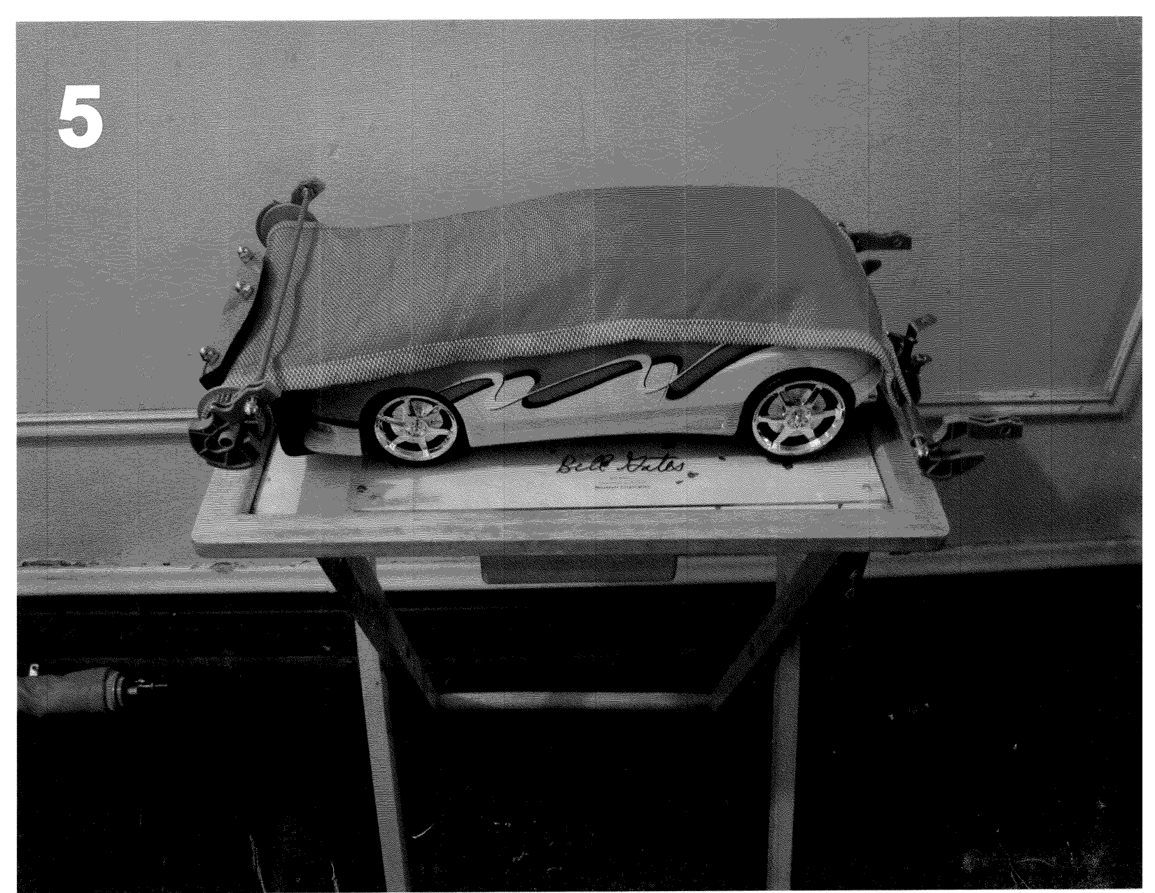

FIG. 3 shows SKYLINE ELECTRIC COVER set on two supports AB and A1B1 of BASE OF SUPPORT. In FIG. 3 are shown also 4 long metallic rods which will be mounted on the parts A,B, and A1,B1. These metallic rods have two functions:

First function is to connect parts A-B and A1-B1 of base of support. Second function is to set the length and width of Base of support of the SKYLINE ELECTRIC COVER to fit to the dimensions of the airplane or helicopter.

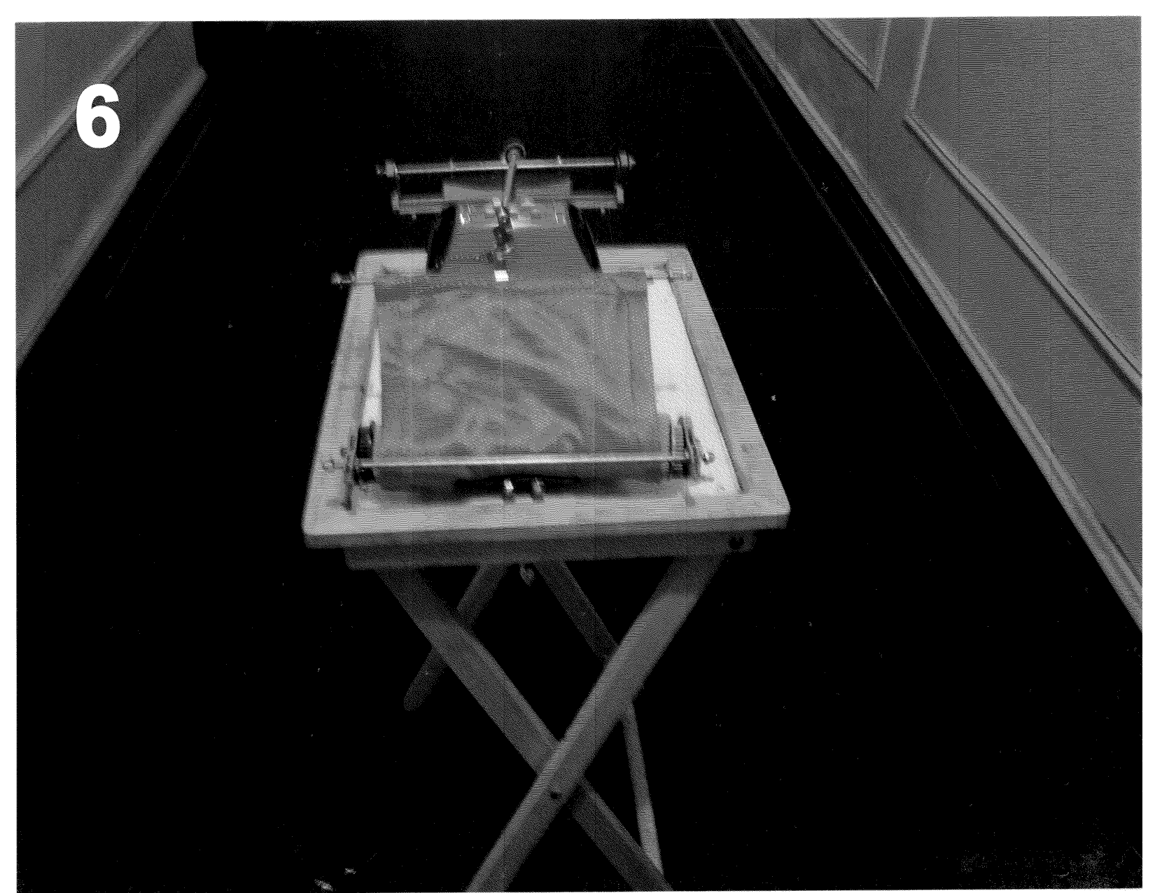

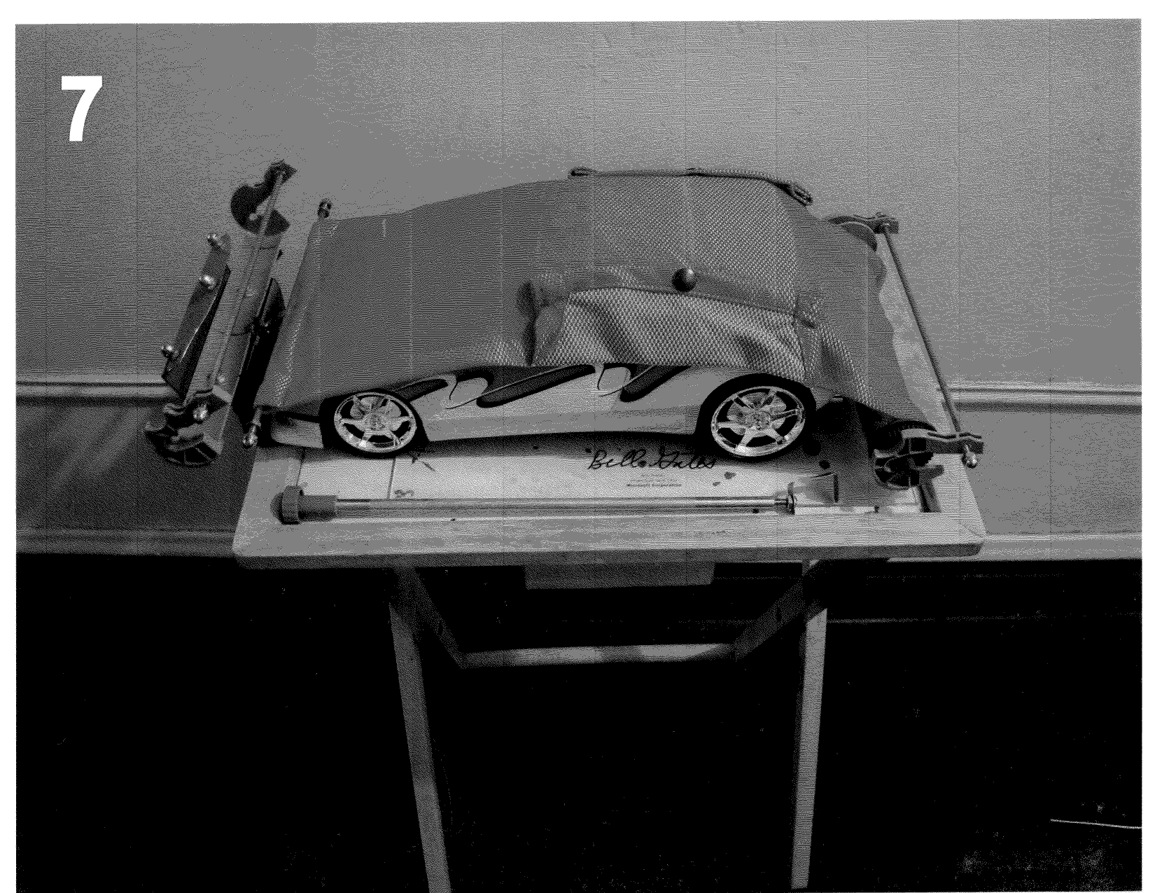

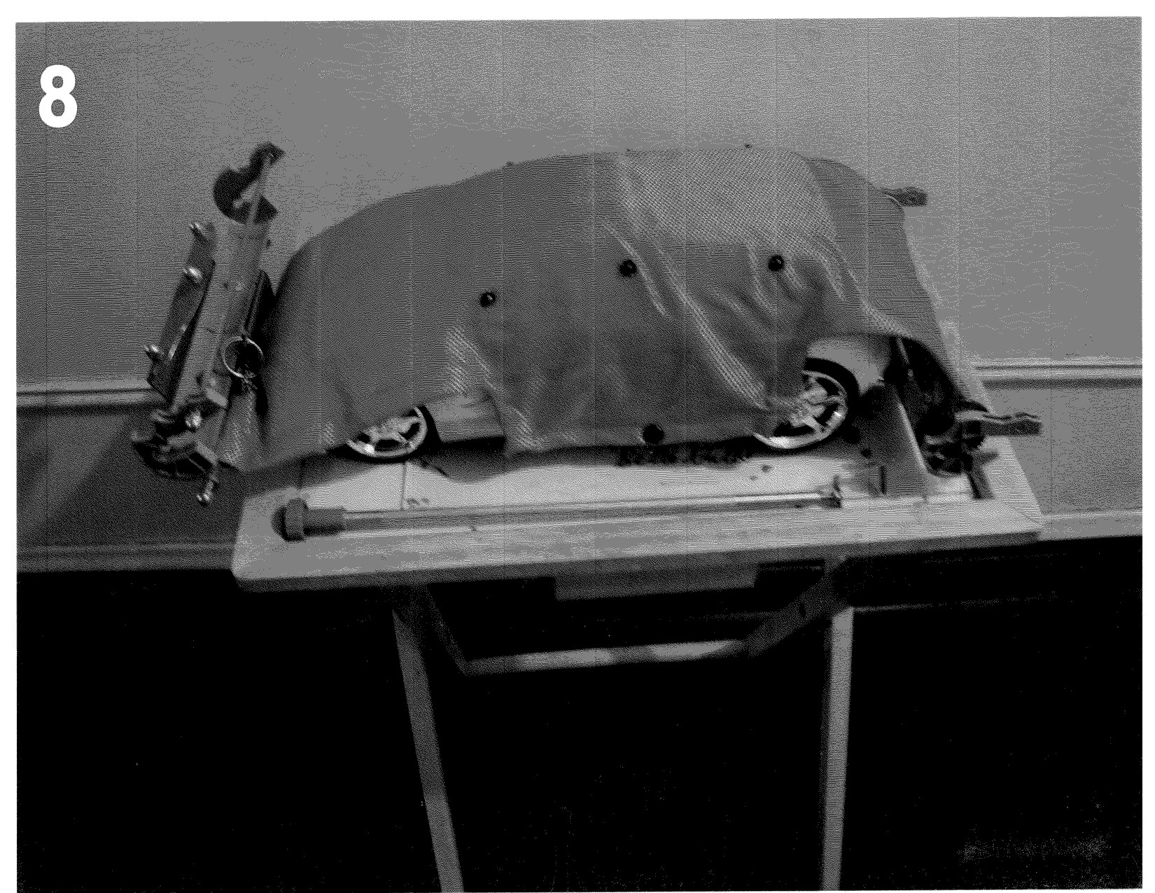

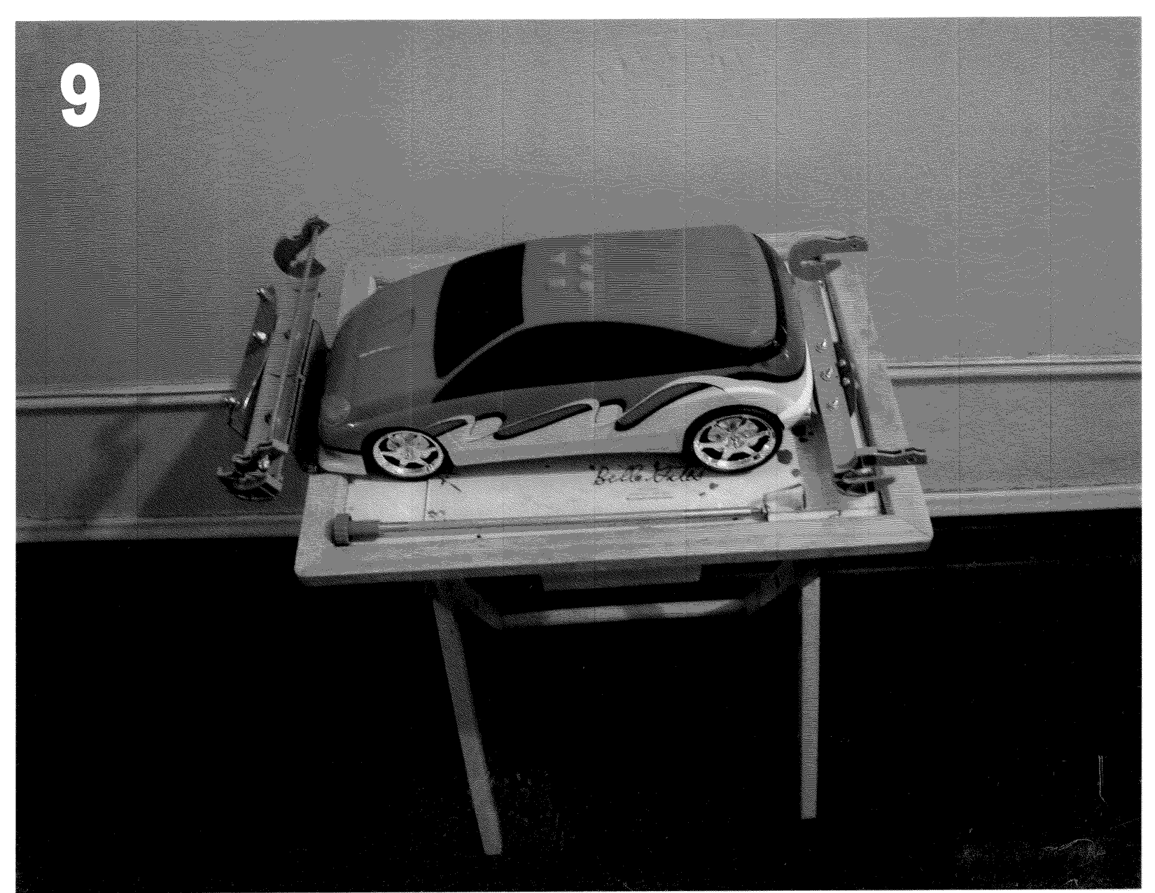

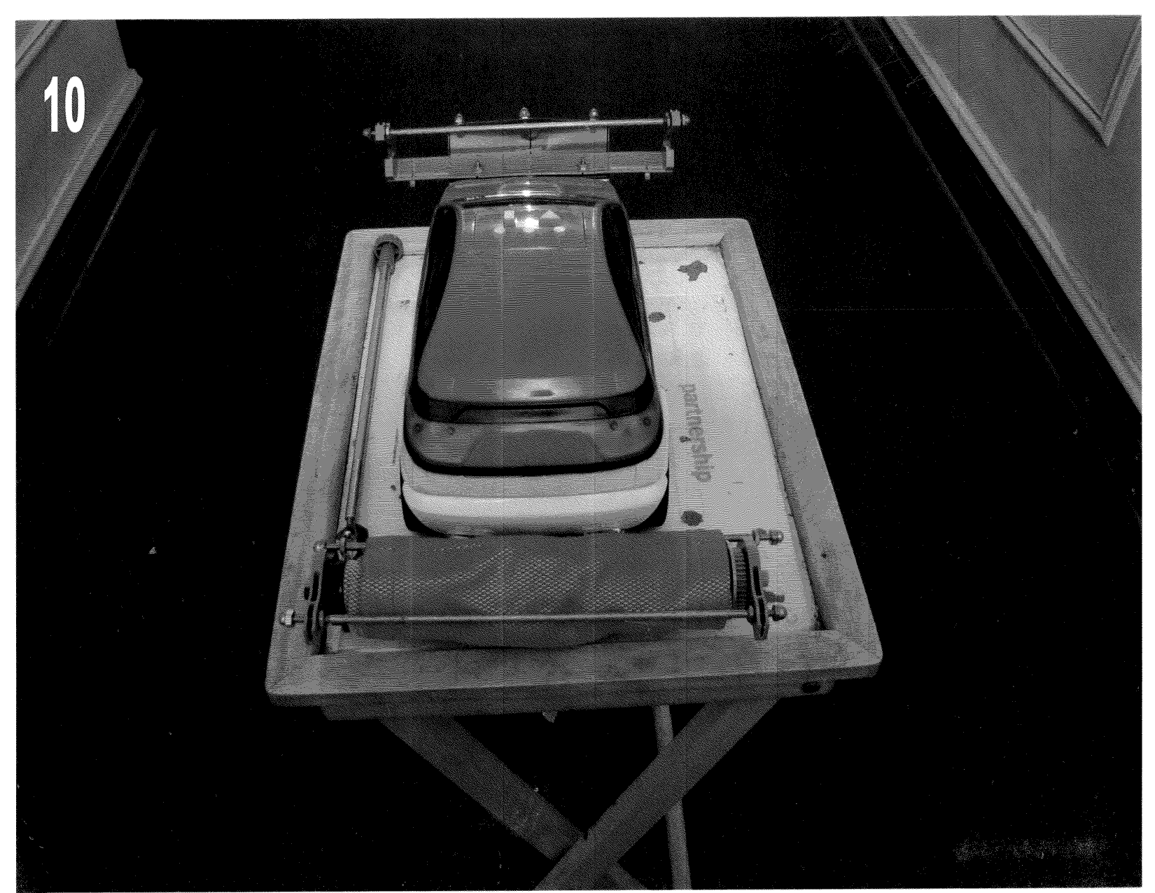

FIG. 4 shows Retractable Holder and ELECTRIC BLANKET mounted on part A1 of base of support and the support part of the other side of Electric Blanket on part B1 of Base of support. Part B1 will support mounting of SKYLINE ELECTRIC COVER on it; In FIG. 4 are shown also 4 metallic rods which will be mounted on 8 hooks that are placed on parts A,B and A1,B1 of Base of support.

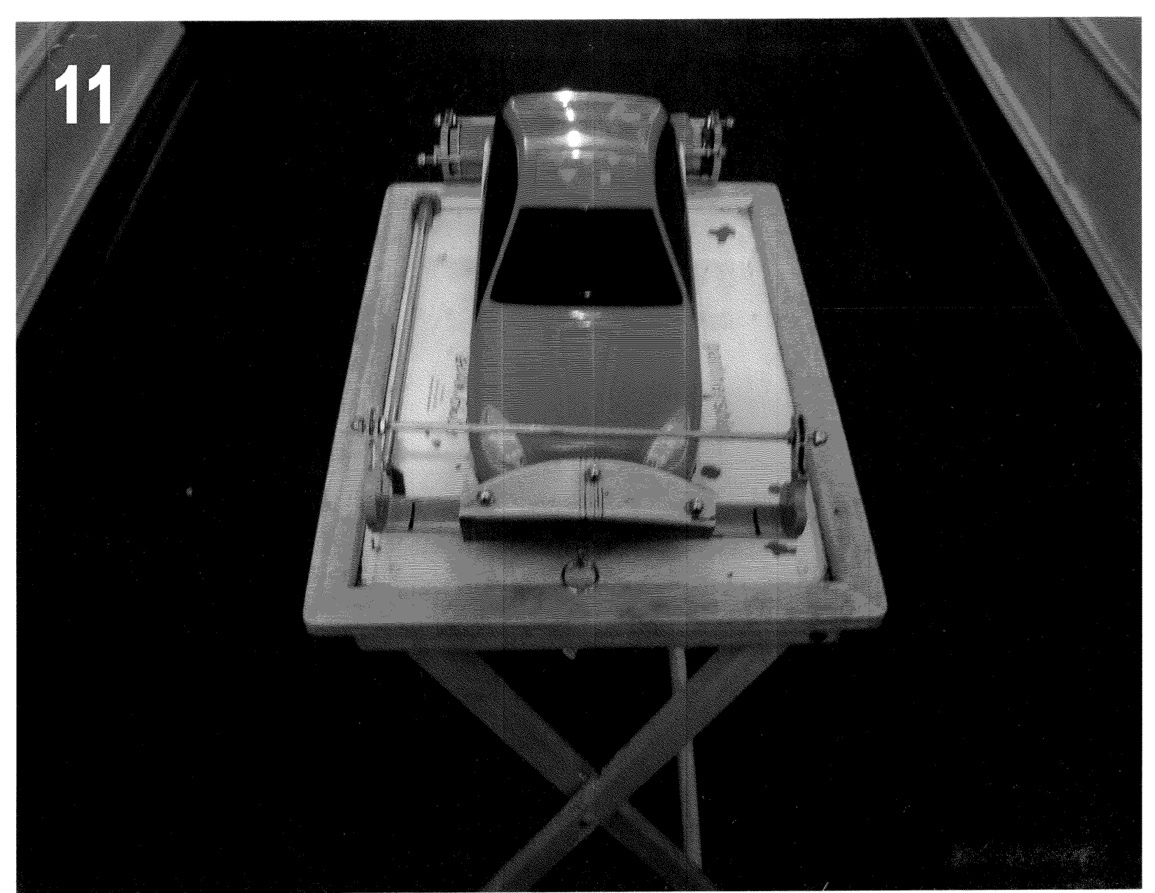

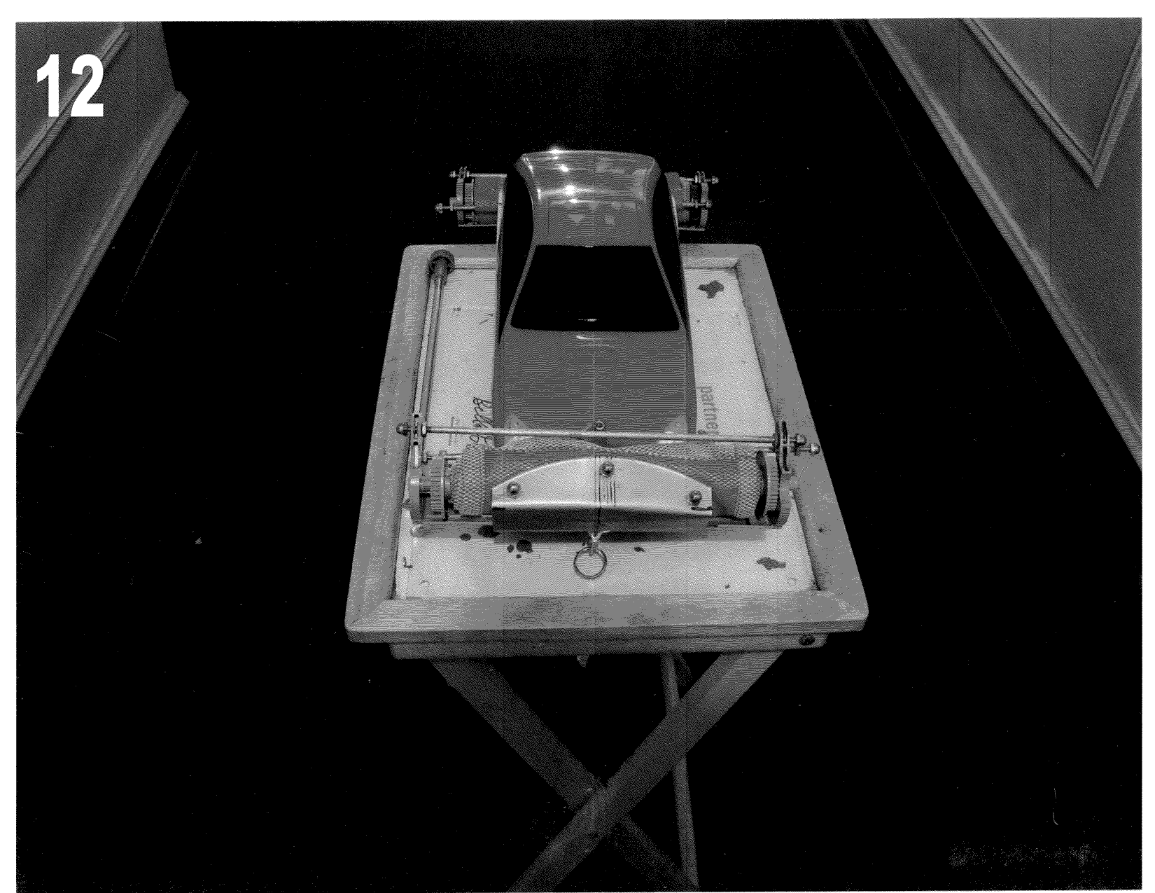

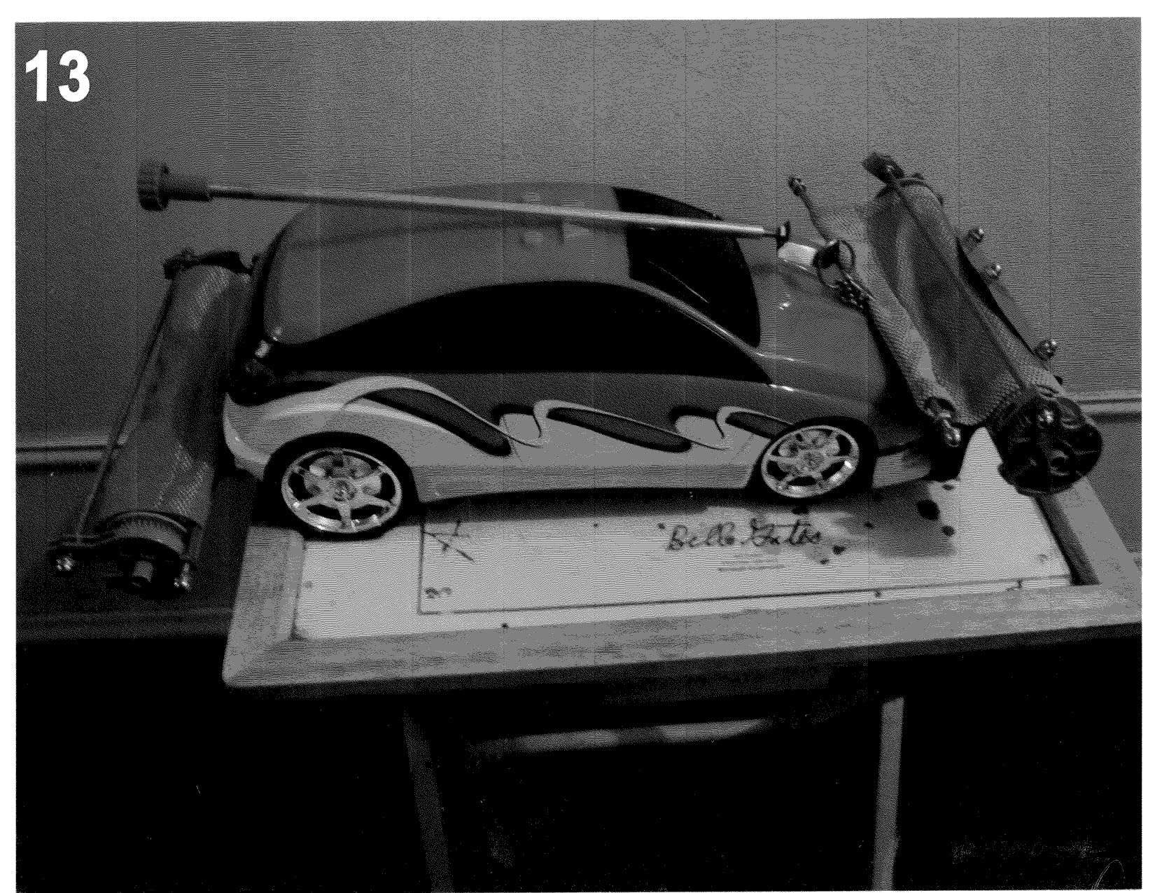

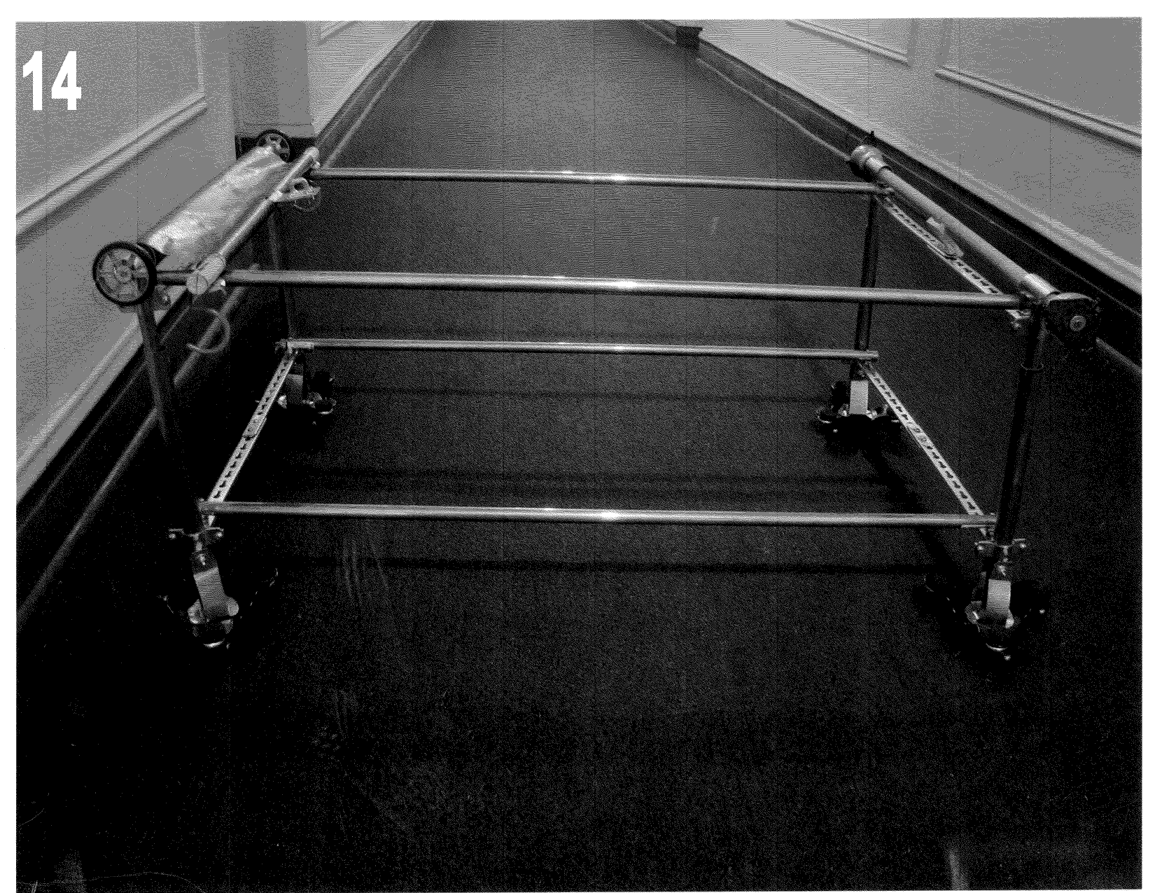

FIG. 5 shows two main elements of my idea:

1.—Skyline Electric Blanket on the airplane

2—Airplane under SKYLINE ELECTRIC BLANKET The rest of parts of Base OF SUPPORT are not shown because they are shown in FIGS. 1, 2, 3 and 4

For a clear presentation of product ELECTRIC BLANKET which will stay over airplanes or helicopters to protect them from snow and ice and thawing ice and snow, I am going to talk about some other characteristics accompanied by figures.

First; In the case of cars Skyline Electric blanket, will have Electrical System extended throughout its surface. In airplanes and helicopters Electrical System may be extended over ELECTRIC BLANKETS on all its surface or could be placed only in certain part of ELECTRIC BLANKET as the shape of airplane view from the air would suggest. FIG. 5 shows the surface of ELECTRIC BLANKET and how the electric wire will be extended over its surface.

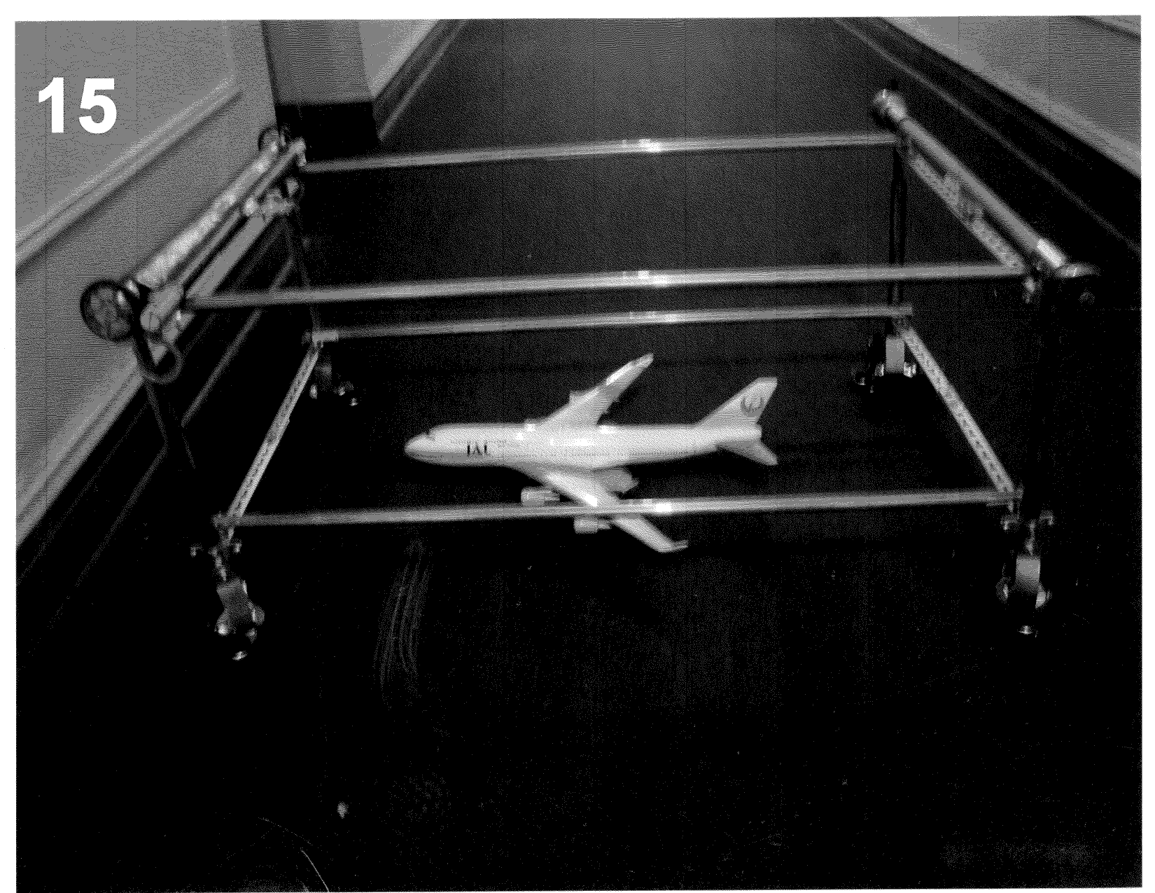

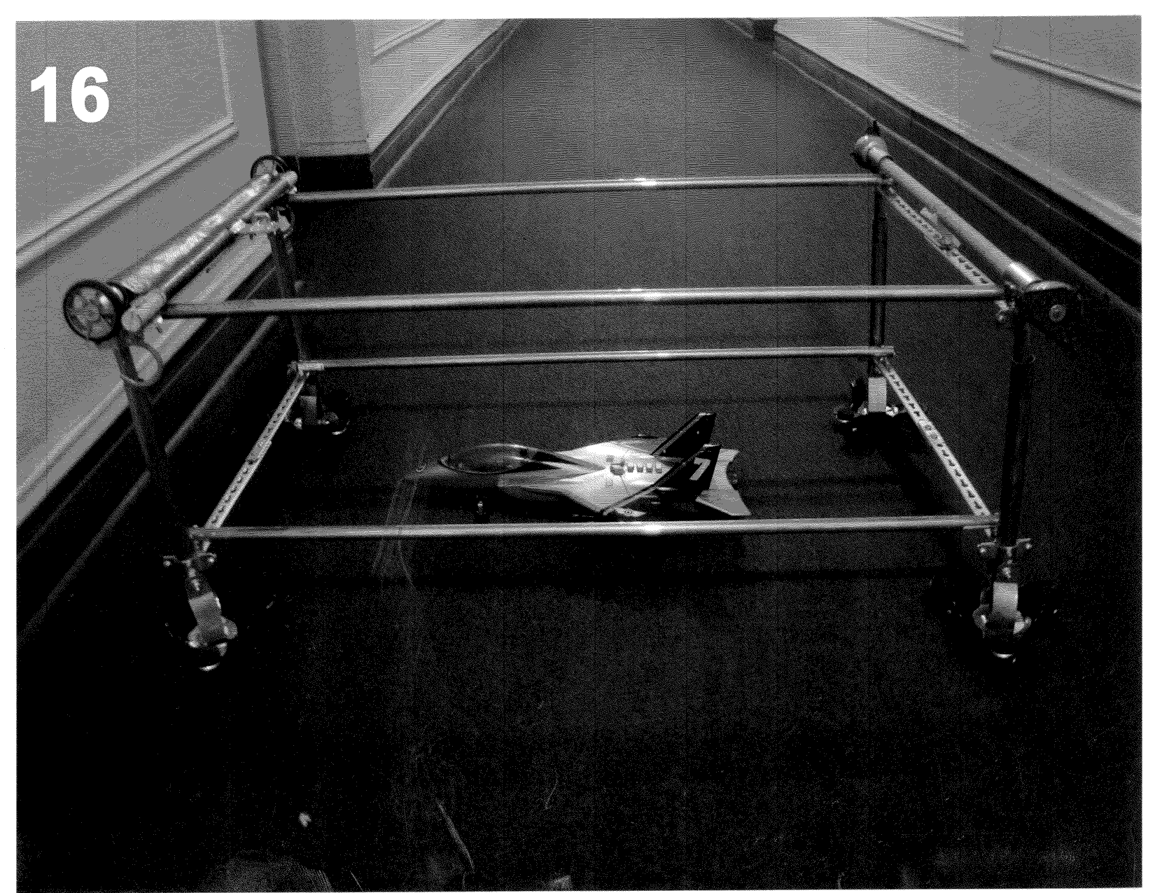

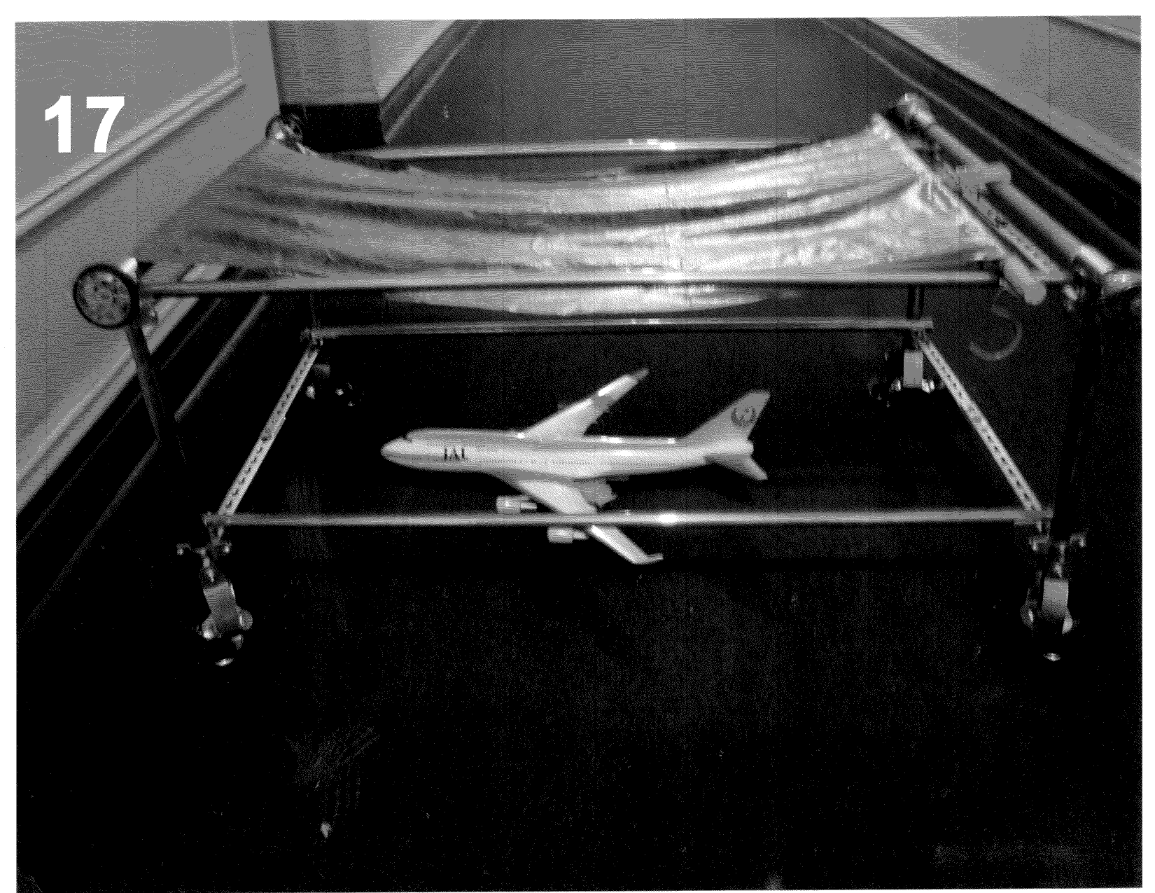

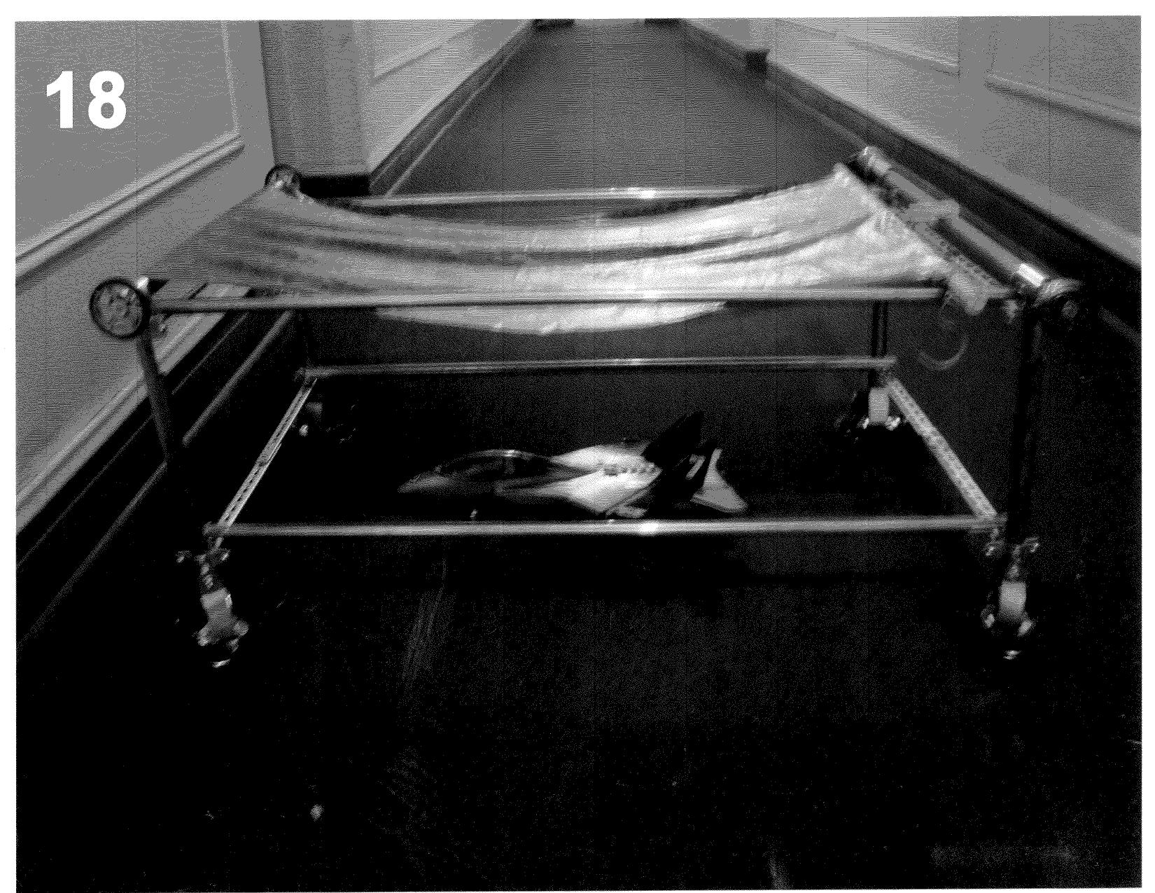

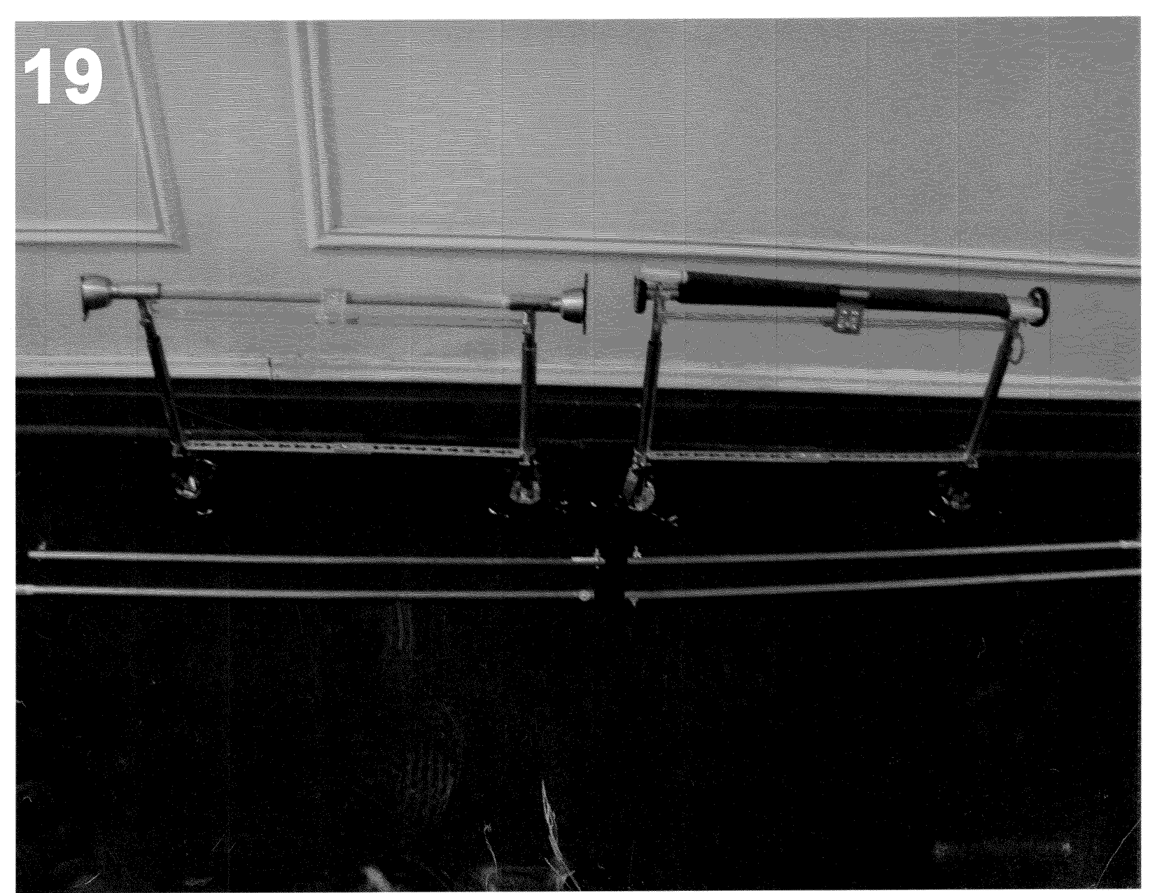

Secondly; the rear vertical tail of the airplane will cause that ELECTRIC BLANKET and its base stay slanted from tail to the head of airplane by having part B1 of base of support with four wheels, raised higher. FIG. 6. In this position the height of ELECTRIC BLANKET will be taller on the side of B1, thus making it easier for the waters to fall down after thawing of the snow.

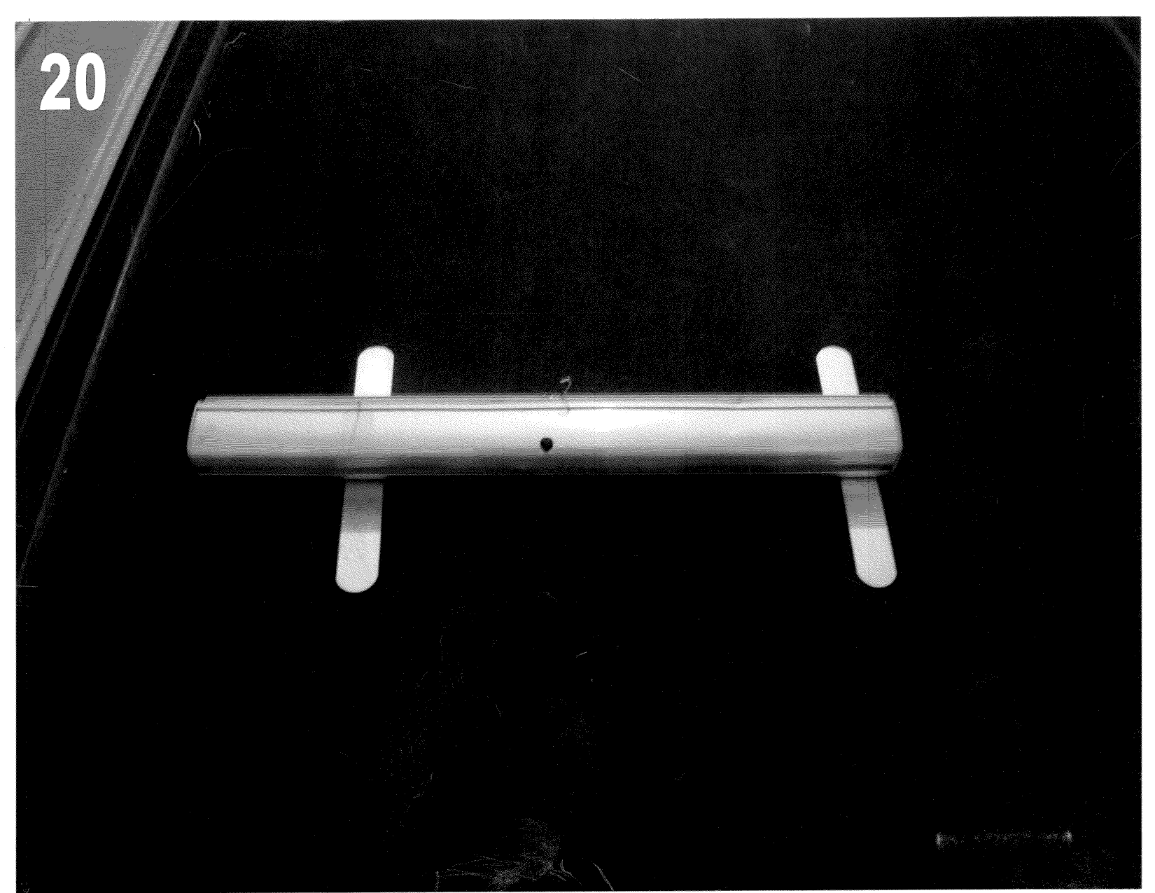

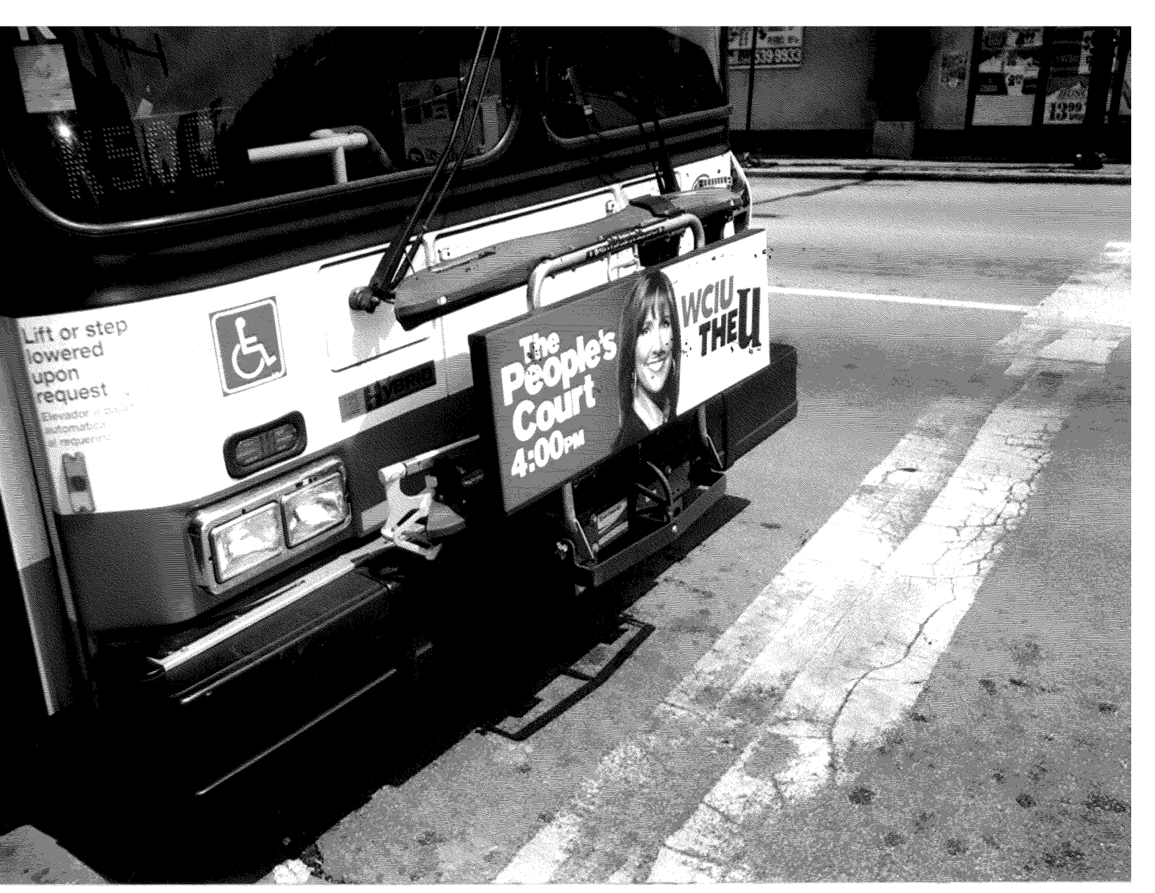

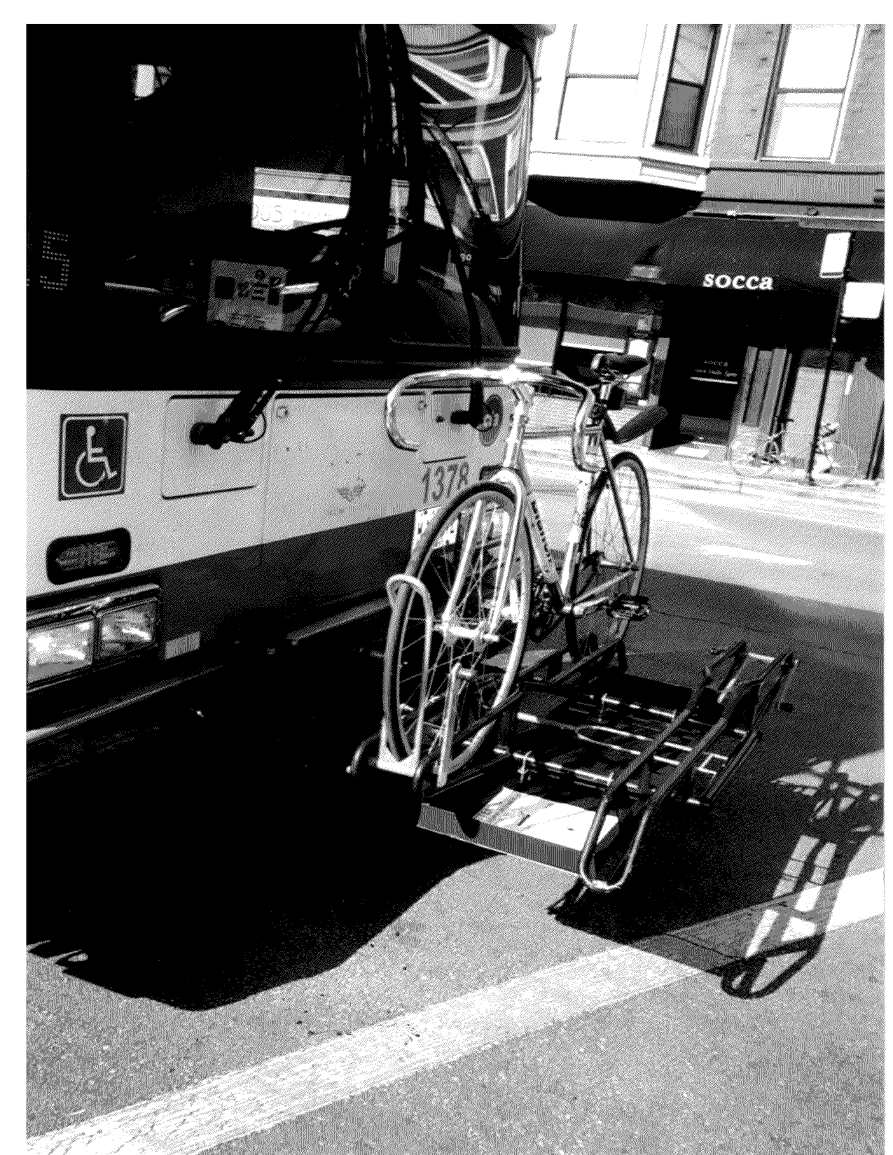

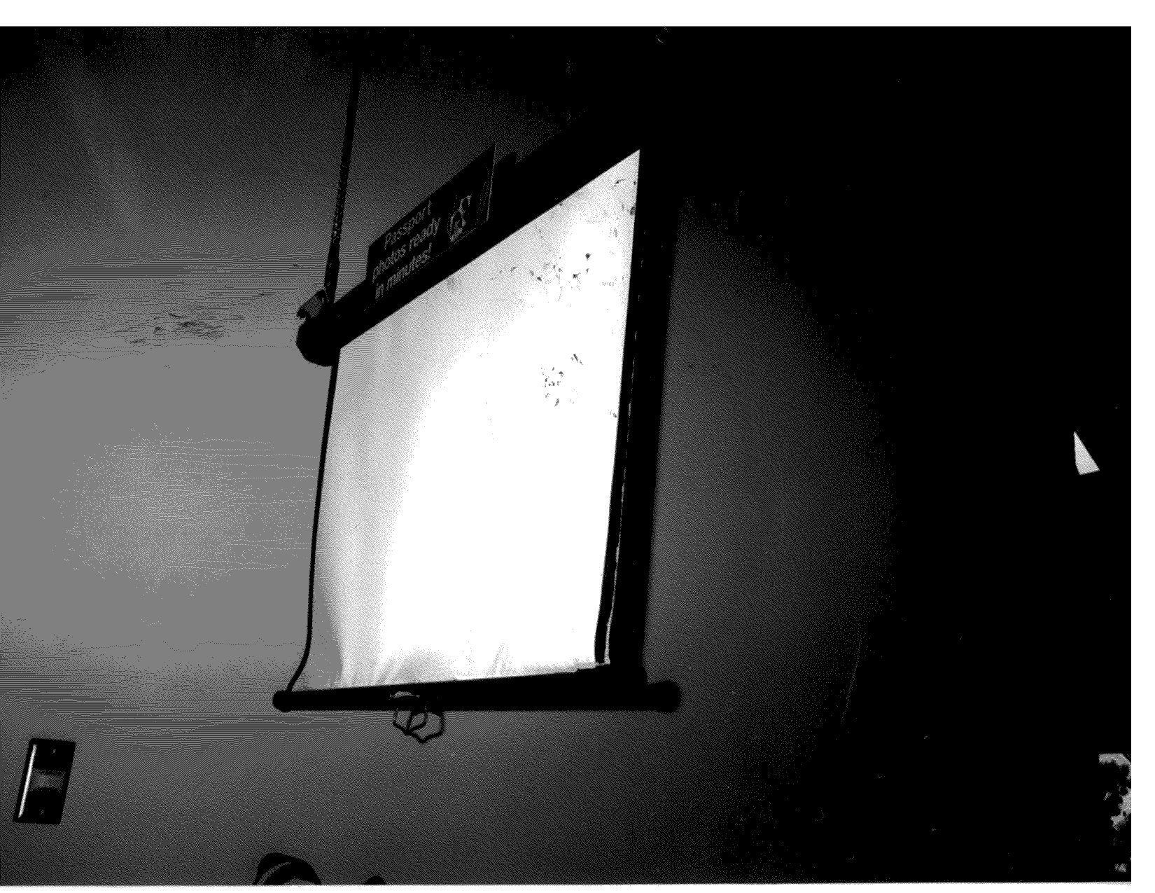

Third; If ELECTRIC BLANKET. will be too high on the side of the tail of airplane, the ELECTRIC BLANKET on the top side on the tail of airplane could be open with calculated dimensions. FIG. 7.

Fourth; THE SKYLINE ELECTRIC COVER AIRPLANE is portable; can be put on and taken off. it is easy to move because is on wheels, under the Base are 4 wheels. When THE SKYLINE ELECTRIC COVER AIRPLANE is taken off it will take very little space in warehouses in airports where many other mechanisms are stored. In winter when snowfall and ice is expected this system can be put together beforehand, by specialized people in the storage facilities and easily brought, on its wheels, over to the airplane or helicopter, and placed over them to protect them from snow and ice for as long as they are in land. Because the base has wheels, to keep it under control when strong winds are present, I think that wheels should have a mechanical system of brakes to stop and let go of the system when needed to bring it to the airplane or take it away.

Fifth; as my system is electro-mechanical I suggest that the electrical system can be turned on and off for thawing by a remote control from a distance of 50-100 meter.

### DESCRIPTION FOR FIGURES

### Description for Pictures

PIC No 1.
Shows skyline electric blanket installed in front of a car and cover card installed in the back.

PIC No. 2
Shows in the back of the car holder for cover car similar to a bus bike holder.

PIC No 3.
Shows holder for skyline electric blanket similar to a bus bike holder in the front of car and in the back same supporter for cover car.

PIC No. 4
Shows skyline electric blanket open 25% being pull for a Pulling Hook from front to back.

PIC No. 5.
Skyline electric blanket open full from front to back covering the car.

PIC No 6.
Shows skyline Electric Blanket open 25% being open by a Pulling hook.

PIC No 7
Shows Skyline cover open from back to front not fully covering sides of car.

PIC No 8.
Shows skyline cover car open full from back to front and covering the left side of car.

PIC No. 9
Shows holder for Skyline Electric Blanket at front and holder for skyline cover at back of the car.

PIC No. 10
Shows in the back Skyline cover closed and Skyline Electric Blanket Holder empty at front of the car

PIC NO. 11
Shows the front of the car with the holder for the Skyline Electric Blanket at front and the Skyline cover in the back of the car.

PIC NO. 12
Shows Skyline Electric Blanket mounted in front of the car and also the Skyline cover mounted in the back of the car.

PIC No. 13
Shows lateral view of the Skyline Cover closed in the back of the car and the skyline Electric Blanket being pull with the pulling hook from the front of the car.

PIC No. 14
Shows support for Skyline Electric Blanket closed for airplane.

PIC No. 15
Shows support for Skyline Electric Blanket closed and passenger airplane as an example.

PIC No. 16
Shows support for Skyline Electric Blanket closed and a military airplane as an example.

PIC No. 17
Shows support for Skyline Electric Blanket full open and passenger airplane.

PIC No. 18
Shows support for Skyline Electric Blanket full open and military airplane.

PIC No. 19
Shows Skyline Electric Blanket disarmed after use.

PIC No. 20
Retractable holder to support Skyline Electric Blanket and Skyline cover for cars and airplanes.

The invention claimed is:

1. A method of MELTING SNOW AND ICE has a simple and understandable configuration and the procedures of using it are easy and convenient. According to my idea inside a Retractable holder is mounted an ELECTRIC BLANKET that gets the power from a battery for cars and works with remote car starter and from a power supply for airplanes; for car cover no power supply is required.

2. The method of claim 1, where in the cost-affecting parameter is that ice is melted in 15 seconds and you save money due to time and no use of human labor.

3. The method of claim 2, where in the cost-affecting parameter is that snow is melted in 7 seconds from the area of contact in cars and airplanes.

4. The method of claim 3, wherein the total time to cover the car is 1 minute.

5. The method of claim 4, wherein in melting snow for airplanes is quick and easy to ensemble and dissemble.

6. The method of claim 5, wherein space for storage in airports for the Skyline Electric cover for airplanes is minimum and can be stored in any warehouse.

7. The method of claim 6, wherein space and cost for car cover is very low and car gets superior protection from environment.
